(19) United States
(12) Patent Application Publication
(10) Pub. No.: US 2017/0266882 A1
(43) Pub. Date: Sep. 21, 2017

(54) METHOD FOR MANUFACTURING COMPOSITE PRODUCT FROM CHOPPED FIBER REINFORCED THERMOSETTING RESIN BY 3D PRINTING

(71) Applicant: Huazhong University of Science and Technology, Wuhan (CN)

(72) Inventors: Chunze YAN, Wuhan (CN); Wei ZHU, Wuhan (CN); Yusheng SHI, Wuhan (CN); Jie LIU, Wuhan (CN)

(21) Appl. No.: 15/615,795

(22) Filed: Jun. 6, 2017

Related U.S. Application Data
(63) Continuation-in-part of application No. PCT/CN2015/079374, filed on May 20, 2015.

(30) Foreign Application Priority Data
Feb. 12, 2015 (CN) 201510075179.1

(51) Int. Cl. B29C 67/00; B33Y 10/00; B29B 11/14; B29C 67/04; B29C 51/02

(52) U.S. Cl. CPC B29C 67/0081; B29C 67/04; B29C 51/02; B29B 11/14; B33Y 10/00; B29K 2101/10

(57) ABSTRACT

A method for manufacturing a composite product, including: 1) preparing a composite powder including 10-50 v. % of a polymer adhesive and 50-90 v. % of a chopped fiber; 2) shaping the composite powder by using a selective laser sintering technology to yield a preform including pores; 3) preparing a liquid thermosetting resin precursor, immersing the preform into the liquid thermosetting resin precursor, allowing a liquid thermosetting resin of the liquid thermosetting resin precursor to infiltrate into the pores of the preform, and exposing the upper end of the preform out of the liquid surface of the liquid thermosetting resin precursor to discharge gas out of the pores of the preform; 4) collecting the preform from the liquid thermosetting resin precursor and curing the preform; and 5) polishing the preform obtained in 4) to yield a composite product.

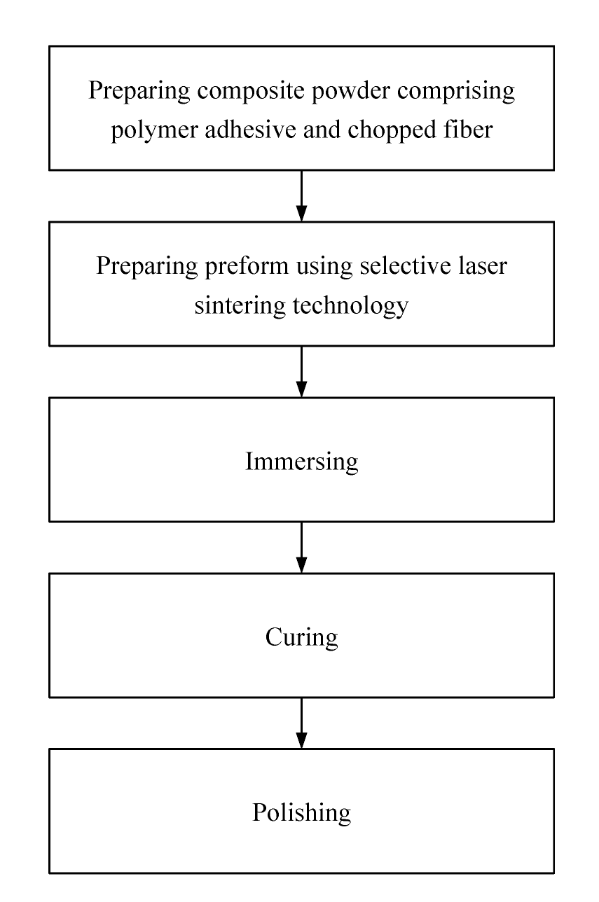

### CROSS-REFERENCE TO RELATED APPLICATIONS

This application is a continuation-in-part of International Patent Application No. PCT/CN2015/079374 with an international filing date of May 20, 2015, designating the United States, now pending, and further claims foreign priority benefits to Chinese Patent Application No. 201510075179.1 filed Feb. 12, 2015. The contents of all of the aforementioned applications, including any intervening amendments thereto, are incorporated herein by reference.

### BACKGROUND OF THE INVENTION

Field of the Invention

The invention relates to a method for manufacturing a composite product from a chopped fiber reinforced thermosetting resin by 3D printing.

Description of the Related Art

3D printing, also known as additive manufacturing (AM) or rapid prototyping manufacturing (RPM), refers to processes used to create a three-dimensional object. Conventional 3D printing includes selective laser sintering (SLS), fused deposition molding (FDM), and stereolithography (SLA), and the binder material used for 3D printing includes thermoplastic resin and UV curing resin. However, products manufactured by conventional 3D printing methods are of low strength, and complex structures, for example, cantilevers, cannot be printed.

### SUMMARY OF THE INVENTION

In view of the above-described problems, it is one objective of the invention to provide a method for manufacturing a composite product from a chopped fiber reinforced thermosetting resin by 3D printing. Following the method, composite products that have relatively high strength, complex structures, and high heat resistance can be manufactured.

To achieve the above objective, in accordance with one embodiment of the invention, there is provided a method for manufacturing a composite product. The method comprises the following steps:
1) preparing a composite powder comprising 10-50 v. % of a polymer adhesive and 50-90 v. % of a chopped fiber;
2) shaping the composite powder by using a selective laser sintering technology to yield a preform comprising pores, where, a porosity of the preform is 10%-60%, and a bending strength is higher than 0.3 megapascal;
3) preparing a liquid thermosetting resin precursor having a viscosity of less than 100 mPa·s, immersing the preform into the liquid thermosetting resin precursor, allowing a liquid thermosetting resin of the liquid thermosetting resin precursor to infiltrate into the pores of the preform, and exposing an upper end of the preform out of a liquid surface of the liquid thermosetting resin precursor to discharge gas out of the pores of the preform;
4) collecting the preform from the liquid thermosetting resin precursor and curing the preform; and
5) polishing the preform obtained in 4) to yield a composite product.

In a class of this embodiment, a particle size of the composite powder in 1) is between 10 and 150 μm.

In a class of this embodiment, the chopped fiber in 1) has a diameter of 6-10 μm and a length of between 10 and 150 μm.

In a class of this embodiment, the selective laser sintering technology in 2) adopts the following parameters: a laser power of 5-15 W, a scanning velocity of 1500-3000 mm/s, a scanning interval of 0.08-0.15 mm, a thickness of a powder layer of 0.1-0.2 mm, and a preheating temperature of 50-200° C.

In a class of this embodiment, in 3), the preform and the liquid thermosetting resin precursor are placed in a vacuum drier and the vacuum drier is evacuated so as to facilitate the infiltration of the liquid thermosetting resin into the pores.

In a class of this embodiment, in 4), the curing treatment is carried out at 50-200° C. for 3-48 hrs.

In a class of this embodiment, in 1), the polymer adhesive is a nylon 12, a nylon 6, a nylon 11, a polypropylene, an epoxy resin, and/or a phenolic resin.

In a class of this embodiment, in 1), the chopped fiber is a carbon fiber, a glass fiber, a boron fiber, a silicon carbide whisker, and/or an aramid fiber.

In a class of this embodiment, in 3), the liquid thermosetting resin adopted by the liquid thermosetting resin precursor is an epoxy resin, a phenolic resin, a polyurethane, a urea-formaldehyde resin, or an unsaturated polyester resin.

In a class of this embodiment, in 4), prior to curing the preform, excess resin is removed from a surface of the preform.

Advantages of the method for manufacturing the composite product from the chopped fiber reinforced thermosetting resin by the 3D printing according to embodiments of the invention are summarized as follows:

1) The selective laser sintering technology is one kind of the 3D printing technology. Such craft is able to selectively sinter the powder of required regions of different layers respectively and stack the layers to form the part directly according to the CAD module, so as to directly manufacture parts with complicate shape and structure, for example, the structure possessing cantilevers. Compared with the conventional composite products of thermosetting resin, such as hand lay-up molding, compression molding, resin transfer molding, spray forming, and continuously filament winding process, the craft of the invention possess short design-manufacture cycle, no mold is required, and parts with complex structures can be integrally manufactured.

2) Compared with the composite products manufactured by conventional 3D printing, the thermosetting resin composite products of the invention possesses more excellent mechanical properties and better heat resistance.

3) The method of the invention has extensive application scope and is suitable to different reinforced fibers and different thermosetting resin systems.

### BRIEF DESCRIPTION OF THE DRAWINGS

The invention is described hereinbelow with reference to accompanying drawings, in which the sole FIGURE is a flow chart of a method for manufacturing a composite product from a chopped fiber reinforced thermosetting resin by 3D printing.

### DETAILED DESCRIPTION OF THE EMBODIMENTS

For further illustrating the invention, experiments detailing a method for manufacturing a composite product from a chopped fiber reinforced thermosetting resin by 3D printing are described below. It should be noted that the following examples are intended to describe and not to limit the invention.

A method for manufacturing a composite product from a chopped fiber reinforced thermosetting resin by 3D printing is illustrated in the sole FIGURE. The method is summarized as follows:

1) A composite powder suitable for selective laser sintering 3D printing technology is prepared. The composite powder comprises the following raw materials according to volume ratios: 10-50 v. % of a polymer adhesive and 50-90 v. % of a chopped fiber, in which, the composite powder comprising the polymer adhesive and the chopped fiber has a grain size of 10-15 μm, preferably 10-100 μm. Generally, the longer the fiber length is, the better the reinforced effect is, however, when the fiber length exceeds 150 μm, the quality of the powder layer is affected, and finally the accuracy of the parts is affected. Too short of the fiber results in enlargement of the surface area and therefore adherence to a roller. The volume percent of the polymer adhesive is preferably 10-30%, because on the premise of ensuring the basic strength of the preform, the less the content of the polymer adhesive is, the larger the porosity of the preform is, the more the resin infiltrated into the pores later, and the higher the final strength is.

Furthermore, the polymer adhesive is polymer materials possessing a certain thermal resistance performance, and specifically is one selected from the group consisting of a nylon 12, a nylon 6, a nylon 11, a polypropylene, an epoxy resin, a phenolic resin, and a combination thereof.

In addition, the chopped fiber is optionally a carbon fiber, a glass fiber, a boron fiber, a silicon carbide whisker, and/or an aramid fiber. The chopped fiber has a diameter of 6-10 μm, a length of between 10 and 150 μm, and preferably 50-100 μm. Generally, the longer the fiber length is, the better the reinforced effect is. But when the fiber length exceeds 150 μm, the quality of the powder layer will be affected.

2) The selective laser sintering technology is adopted to form a preform with pores. Optimized craft parameters of the selective laser sintering technology are adopted to prepare the preform of the part. The preform not only satisfies the strength requirement for the subsequent treatment, but also exists with a porous structure including a large quantity of communicating channels.

In order to satisfy the strength requirement for the subsequent treatment, a bending strength of the preform exceeds 0.3 megapascal. When the strength is too low, some parts with thin walls will be easily destructed. In the meanwhile, communicating channels are required in the preform to make the resin infiltrated into the preform. The higher the porosity is, the more the resin is infiltrated, and the better the final property is. Generally, the porosity is required to be 10-60%. When the porosity is too low, the resin infiltrated is too little, and the final part has low strength. When the porosity is too high, the strength of the elementary preform is low, which is unable to satisfy the requirements for the subsequent treatment.

Besides, the craft parameters for formation using the selective laser sintering technology are as follows: a laser power of 5-15 W, a scanning velocity of 1500-3000 mm/s, a scanning interval of 0.08-0.15 mm, a thickness of a powder layer of 0.1-0.2 mm, and a preheating temperature of 50-200° C. Specific craft parameters are determined according to the classifications of the polymer adhesive and the chopped fibers in the practical processing.

3) The preform is placed in a liquid thermosetting resin precursor for infiltration as a post treatment. The post treatment is carried out as follows:

3.1) The viscosity is regulated by raising the temperature or adding an adhesive to prepare the liquid thermosetting resin precursor having the viscosity of smaller than 100 mPa·s, because if the viscosity is too large, the resistance of the liquid flowing increases, which restricts the infiltration of the resin. The liquid thermosetting resin precursor is prepared in a resin box. The thermosetting resin adopted by the liquid thermosetting resin precursor is an epoxy resin, a phenolic resin, a polyurethane, a urea-formaldehyde resin, or an unsaturated polyester resin which can be processed into the liquid precursor having low viscosity and can be fluently infiltrated into the pores of the elementary preform.

3.2) The preform is immersed into the liquid thermosetting resin precursor to infiltrate the liquid thermosetting resin into the pores of the preform, and an upper end of the preform is kept above the liquid level to discharge the gas out of the pores of the preform. The infiltration process is carried out in air. Preferably, the infiltration process is carried out in vacuum: the resin box accommodating the preform and the liquid thermosetting resin precursor is placed in the vacuum drier and the vacuum drier is evacuated to facilitate the infiltration of the liquid thermosetting resin into the pores of the preform.

4) After total infiltration, the preform is taken out from the liquid thermosetting resin precursor, cleaned by brushing superfluous resin by a brush or scrapping the superfluous resin by a scrapper, then cured. Preferably, the curing is performed at 50-200° C. for 3-48 hrs.

5) The preform obtained in 4) is polished to yield a composite product.

In summary, a general idea of the invention includes the following two respects: one is that the selective laser sintering technology is adopted to form the enhanced skeleton preform adhered by polymers and possessing high porosity. The other is that the preform is then performed with infiltration of thermosetting resin and high-temperature curing for crosslinking to obtain the composite product from a chopped fiber reinforced thermosetting resin.

### EXAMPLE 1

1) The solvent precipitation is adopted to prepare the composite powder comprising the nylon 12 and the chopped carbon fibers, in which the nylon 12 accounts for 20 v. %, and the powder having a grain size of 10-100 μm is screened for shaping using the selective laser sintering.

2) The selective laser sintering technology is adopted to form the preform with pores. Craft parameters for the selective laser sintering technology are as follows: a laser power of 5 W, a scanning velocity of 2000 mm/s, a scanning interval of 0 1 mm, a thickness of a powder layer of 0.1 mm, and a preheating temperature of 168° C. The preform of the composite product of nylon 12/carbon fibers is shaped, and it is known from tests that the bending strength of the preform is 1.5 megapascal and the porosity thereof is 58%.

3) A phenolic epoxy resin F-51 and a curing agent methylnadic anhydride are mixed according to a ratio of 100:91, and a curing accelerator 2,4,6-tris (dimethylaminomethyl) phenol (short for DMP-30) having a weight accounting for 0.1 wt. % of the epoxy resin is added, heated to 130° C., and intensively stiffing a mixture to be uniform. A viscosity of the infiltration system is regulated to be 20 mPa·s. The phenolic epoxy resin F-51 is a product provided by Yueyang Baling Petrochemical Co., Ltd. The methylnadic anhydride and DMP-30 are products provided by the Shanghai Chengyi Hi-tech Development Co., Ltd.

4) The resin box is placed in the vacuum drier, and the preform is directly immersed into the precursor solution during which the upper end of the preform is kept above the liquid level to discharge the gas out of the preform via the upper end thereof during the infiltration process. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed respectively at 150° C. for 5 hrs and 200° C. for another 5 hrs. The part is taken out from the oven after being cooled, and a surface of the part is then polished to obtain the composite product from a carbon fiber reinforced phenolic epoxy resin.

### EXAMPLE 2

1) The solvent precipitation is adopted to prepare the composite powder comprising the nylon 12 and the chopped glass fibers, in which the nylon 12 accounts for 25 v. %, and the powder having a grain size of 20-150 μm is screened for shaping using the selective laser sintering.

2) The selective laser sintering technology is adopted to form the preform with pores. Craft parameters for the selective laser sintering technology are as follows: a laser power of 8 W, a scanning velocity of 2500 mm/s, a scanning interval of 0 1 mm, a thickness of a powder layer of 0.15 mm, and a preheating temperature of 168° C. The preform of the composite product of nylon 12/glass fibers is shaped, and it is known from tests that the bending strength of the preform is 2.0 megapascal and the porosity thereof is 53%.

3) An epoxy resin CYD-128 and a curing agent 2,3,6-tetrahydro-3-methylphthalic anhydride are mixed according to a ratio of 100:85, and a curing accelerator 2,4,6-tris (dimethylaminomethyl) phenol (short for DMP-30) having a weight accounting for 0.1 wt. % of the epoxy resin is added, heated to 110° C., and intensively stiffing a mixture to be uniform. A viscosity of the infiltration system is regulated to be 30 mPa·s. The epoxy resin CYD-128 is a product provided by Yueyang

Baling Petrochemical Co., Ltd. The 2,3,6-tetrahydro-3-methylphthalic anhydride and DMP-30 are products provided by the Shanghai Chengyi Hi-tech Development Co., Ltd.

4) The resin box is placed in the vacuum drier, and the preform is directly immersed into the precursor solution during which the upper end of the preform is kept above the liquid level to discharge the gas out of the preform via the upper end thereof during the infiltration process. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed respectively at 130° C. for 3 hrs and 150° C. for 5 hrs. The part is taken out from the oven after being cooled, and a surface of the part is then polished to obtain the composite product from a glass fiber reinforced epoxy resin.

### EXAMPLE 3

1) The mechanical mixing is adopted to prepare the composite powder comprising the polypropylene and the chopped aromatic polyamide fibers, in which the polypropylene accounts for 30 v. %, and the powder having a grain size of 10-80 μm is screened for shaping using the selective laser sintering.

2) The selective laser sintering technology is adopted to form the preform with pores. Craft parameters for the selective laser sintering technology are as follows: a laser power of 11 W, a scanning velocity of 2500 mm/s, a scanning interval of 0 1 mm, a thickness of a powder layer of 0.1 mm, and a preheating temperature of 105° C. The preform of the composite product of polypropylene/aromatic polyamide fibers is shaped, and it is known from tests that the bending strength of the preform is 1.3 megapascal and the porosity thereof is 43%.

3) Unsaturated polyester resin and a curing agent methyl ethyl ketone peroxide are mixed according to a ratio of 100:1, and a curing accelerator cobalt naphthenate having a weight accounting for 0.1 wt. % of the epoxy resin is added, heated to 45° C., and intensively stiffing a mixture to be uniform. A viscosity of the infiltration system is regulated to be 30-40 mPa·s. The unsaturated polyester resin is a product of Synolite 4082-G-33N provided by Jinling DSM Resin Co., Ltd. The methyl ethyl ketone peroxide is a product provided by Jiangyin City Forward Chemical Co., Ltd. The cobalt naphthenate is commercially available.

4) The resin box is placed in the vacuum drier, and the preform is directly immersed into the precursor solution during which the upper end of the preform is kept above the liquid level to discharge the gas out of the preform via the upper end thereof during the infiltration process. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed at 100° C. for 24 hrs. The part is taken out from the oven after being cooled, and a surface of the part is then polished to obtain the composite product from an aromatic polyamide fiber reinforced epoxy resin.

### EXAMPLE 4

1) The mechanical mixing is adopted to prepare the composite powder comprising the nylon 11 and the chopped boron fibers, in which the nylon 11 accounts for 25 v. %, and the powder having a grain size of 10-100 μm is screened for shaping using the selective laser sintering.

2) The selective laser sintering technology is adopted to form the preform with pores. Craft parameters for the selective laser sintering technology are as follows: a laser power of 11 W, a scanning velocity of 2000 mm/s, a scanning interval of 0.1 mm, a thickness of a powder layer of 0.15 mm, and a preheating temperature of 190° C. An elementary preform of the composite product of nylon 11/boron fibers is shaped, and it is known from tests that the bending strength of the preform is 0.8 megapascal and the porosity thereof is 48%.

3) A phenolic resin solution is prepared by phenolic resin and alcohol according to a weight ratio of 1:1, the phenolic resin solution is placed in a water bath at a constant temperature and heated to 40-60° C., and a viscosity of the infiltration system is regulated to less than 50 mpa·s. The phenolic resin is a boron-modified phenolic resin with a product number of THC-400 provided by Xi'an Taihang flame retardant Co., Ltd. The alcohol is commercially available.

4) The preform is directly immersed into the precursor solution during which the upper end of the preform is kept above the liquid level to discharge the gas out of the preform via the upper end thereof during the infiltration process. The infiltration is carried out for several times until the porous structures are totally filled. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed at 180° C. for 24 hrs. The part is taken out from the oven after being cooled, and a surface of the part is then polished to obtain the composite product from a boron fiber reinforced phenolic resin.

### EXAMPLE 5

1) The mechanical mixing is adopted to prepare the composite powder comprising the nylon 6 and the chopped silicon carbide whiskers, in which the nylon 6 accounts for 50 v. %, and the powder having a grain size of 10-100 μm is screened for shaping using the selective laser sintering.

2) The selective laser sintering technology is adopted to form the preform with pores. Craft parameters for the selective laser sintering technology are as follows: a laser power of 15 W, a scanning velocity of 1500 mm/s, a scanning interval of 0.08 mm, a thickness of a powder layer of 0.2 mm, and a preheating temperature of 200° C. The preform of the composite product of nylon 6/silicon carbide whiskers is shaped, and it is known from tests that the bending strength of the preform is 1.6 megapascal and the porosity thereof is 60%.

3) Isocyanate and polyhydric alcohol are two primary parts of the polyurethane thermosetting resin. Polyether polyol, polyarylpolymethylene-isocyanate (PAPI), stannous octoate, triethanolamine, and water are uniformly mixed according to weight ratio of 100:100:0.4:0.6:0.1, and heated to 40° C. The viscosity is regulated to less than 100 mPa·s to obtain a polyurethane thermosetting resin precursor.

4) The resin box is placed in the vacuum drier, and the preform is directly immersed into the precursor solution during which the upper end of the preform is kept above the liquid level to discharge the gas out of the preform via the upper end thereof during the infiltration process. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed at 100° C. for 24 hrs. The part is taken out from the oven after being cooled, and a surface of the part is then polished to obtain the composite product from a silicon carbide whisker reinforced polyurethane resin.

### EXAMPLE 6

1) The mechanical mixing is adopted to prepare the composite powder comprising the epoxy resin and the chopped glass fibers, in which the epoxy resin accounts for 10 v. %, and the powder having a grain size of 10-100 μm is screened for shaping using the selective laser sintering.

2) The selective laser sintering technology is adopted to form the preform with pores. Craft parameters for the selective laser sintering technology are as follows: a laser power of 8 W, a scanning velocity of 3000 mm/s, a scanning interval of 0.15 mm, a thickness of a powder layer of 0.1 mm, and a preheating temperature of 50° C. The preform of the composite product of epoxy resin/glass fibers is shaped, and it is known from tests that the bending strength of the preform is 0.8 megapascal and the porosity thereof is 57%.

3) A urea-formaldehyde resin precursor with low viscosity is synthesized according to the alkali-acid-alkali means. Firstly, 8 g of hexamethylenetetramine is added to 500 mL of a 36% methanol solution, the temperature is increased to 55° C. by an oil bath, and 50 g of a first batch of urea is added for carrying out reaction for 60 min The temperature is increased to 90° C., and a 70 g of a second batch of urea is added for reaction for 40 min, during which 20% sodium hydrate is added to regulate a pH value to 5-6. After the reaction, the pH value is regulated to 7-8, and 20 g of a third batch of urea is added for reaction for 20 min, and the pH value is regulated to 7-8 before the reaction is finished. Thus, a urea-formaldehyde rein precursor with low viscosity is yielded.

4) The resin box is placed in the vacuum drier, and the preform is directly immersed into the precursor solution during which the upper end of the preform is kept above the liquid level to discharge the gas out of the preform via the upper end thereof during the infiltration process. The vacuum drier is then evacuated to accelerate the resin to infiltrate into the preform. The preform after infiltration is taken out and the superfluous resin on the surface is cleaned.

5) The part after the infiltration is placed in the oven for curing. The curing is performed at 50° C. for 48 hrs. The part is taken out from the oven after being cooled, and a surface of the part is then polished to obtain the composite product from a glass fiber reinforced urea-formaldehyde resin.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for manufacturing a composite product, comprising:
1) preparing a composite powder comprising 10-50 v. % of a polymer adhesive and 50-90 v. % of a chopped fiber;
2) shaping the composite powder by using a selective laser sintering technology to yield a preform comprising pores, wherein a porosity of the preform is 10%-60%, and a bending strength of the preform is higher than 0.3 megapascal;
3) preparing a liquid thermosetting resin precursor having a viscosity of less than 100 mPa·s, immersing the preform into the liquid thermosetting resin precursor, allowing a liquid thermosetting resin of the liquid thermosetting resin precursor to infiltrate into the pores of the preform, and exposing an upper end of the preform out of a liquid surface of the liquid thermosetting resin precursor to discharge gas out of the pores of the preform;
4) collecting the preform from the liquid thermosetting resin precursor and curing the preform; and
5) polishing the preform obtained in 4) to yield a composite product.

2. The method of claim 1, wherein a particle size of the composite powder in 1) is between 10 and 150 μm.

3. The method of claim 1, wherein the chopped fiber in 1) has a diameter of 6-10 μm and a length of between 10 and 150 μm.

4. The method of claim 1, wherein the selective laser sintering technology in 2) adopts the following parameters: a laser power of 5-15 W, a scanning velocity of 1500-3000 mm/s, a scanning interval of 0.08-0.15 mm, a thickness of a powder layer of 0.1-0.2 mm, and a preheating temperature of 50-200° C.

5. The method of claim 1, wherein in 3), the preform and the liquid thermosetting resin precursor are placed in a vacuum drier and the vacuum drier is evacuated.

6. The method of claim 1, wherein in 4), the curing treatment is carried out at 50-200° C. for 3-48 hrs.

7. The method of claim 1, wherein in 1), the polymer adhesive is a nylon 12, a nylon 6, a nylon 11, a polypropylene, an epoxy resin, and/or a phenolic resin.

8. The method of claim 1, wherein in 1), the chopped fiber is a carbon fiber, a glass fiber, a boron fiber, a silicon carbide whisker, and/or an aramid fiber.

9. The method of claim 1, wherein in 3), the liquid thermosetting resin adopted by the liquid thermosetting resin precursor is an epoxy resin, a phenolic resin, a polyurethane, a urea-formaldehyde resin, or an unsaturated polyester resin.

10. The method of claim 1, wherein in 4), prior to curing the preform, excess resin is removed from a surface of the preform.
